(19) United States
(12) Patent Application Publication
(10) Pub. No.: US 2006/0227213 A1
(43) Pub. Date: Oct. 12, 2006

(54) Car image recording system with auto shut-off function

(76) Inventor: Chih Peng Kuo, Taipei (TW)

Correspondence Address: MARTINE PENILLA & GENCARELLA, LLP, 710 LAKEWAY DRIVE, SUITE 200, SUNNYVALE, CA, 94085, US

(21) Appl. No.: 11/331,329

(22) Filed: Jan. 11, 2006

(30) Foreign Application Priority Data
Apr. 12, 2005 (TW) 94111550

(51) Int. Cl. G11B 5/00; H04N 7/18

(52) U.S. Cl. 348/148; 360/5

(57) ABSTRACT

A car image recording system with auto shut-off function includes a sensing device. The sensing device senses an external impact, and after the impact time exceeds a predetermined time, the sensing device sends a stopping message to stop actions of the car image recording system. The sensing device includes a sensing switch and a timer. The sensing switch generates a strike message when sensing an external impact and sends the strike message to the timer. The timer generates a stopping message after having received the strike message for a predetermined time and sends the stopping message to the car image recording system for stopping the actions of the car image recording system.

### BACKGROUND OF THE INVENTION

a) Field of the Invention

The invention relates to a car image recording system, more particularly, to a car image recording system with auto shut-off function.

b) Description of the Related Art

In traffic accidents, it is often difficult to determine who is responsible for the crash because parties involved would have different says and would accuse the other party of being at fault, and reconstructing the accident base on the traces from the crash would take a lot of manpower and time. Thus, most accidents are settled outside of the court. However, it seems to be against social justice and fairness when the person who caused the accident due to his negligence to traffic laws easily resolves the situation without being harshly punished.

In view of the above, many cars are installed with car image recording systems to record any situation the cars may encounter. Nonetheless, the car image recording systems on the market have flaws, one of which is that the car image recording system can only store limited image data. When an accident occurs, if the car image recording system is not turned off at an appropriate time, critical images, like images of the accident in progress, may be recorded over with subsequent images, and the purpose of installing a car image recording system would have been lost.

In ROC (Taiwan) Patent No. I192491, a car security system with recording function is disclosed. The security system includes a plurality of photographing devices installed on the front, back, left and right sides of the car body, and a displaying device installed in the car which instantly displays images taken by the photographing devices. The driver can be fully aware of situations outside the car through the displaying device, and thereby improves driving safety and decreases blind spots. Furthermore, the images displayed by the displaying device can be stored in an image storage device.

In another ROC (Taiwan) patent, Patent No. M216349, an OLED application system that can be used to monitor images at places including the rear sides inside and outside the car, and the blind spots outside the car. Through the speedy and energy-saving characteristics of OLED image displaying technology, the OLED application system combines the resources in the car and dynamically photographs images inside or outside the car by installing at least one image-capturing device inside or outside the car. The image signals from the image-capturing devices are transmitted via wireless or wired mode to an user interface through a transmitting circuit and are displayed on an OLED displaying device that can use the existing OLED stereo panel or OLED rear view mirror to receive signals from the transmitting circuit and display dynamic images. The user interface can be connected to the transmitting circuit and the OLED displaying device to control the operation mode of the OLED displaying device to switch between displaying monitored images mode and original application mode.

As stated above, the conventional car image recording systems do not provide a shutting off function, which may cause the conventional car image recording systems not to work as expected at critical times.

### BRIEF SUMMARY OF THE INVENTION

An object of the invention is to provide a car image recording system with auto shut-off function. The car image recording system continues to photograph outside images for a predetermined time after the system sustains an external impact, and then the recording system is automatically shut-off; the predetermined time can be set by users. Therefore, no critical image would be recorded over.

The invention discloses a car image recording system that includes a sensing device. The sensing device sends a stopping message after having sensed an external impact for a predetermined time to stop actions of the car image recording system.

The sensing device can be composed of a sensing switch and a timer. When the sensing switch detects an external impact, it generates a strike message and sends the strike message to the timer. After having received the strike message for a predetermined time, the timer generates and transmits a stopping message to stop actions of the car image recording system.

The aforementioned car image recording system also includes: a receiving device, an image digitizer, a scaler, an image compressor, a storage device, an external interface, and a storage device controller.

The abovementioned car image recording system further includes a logic circuit connected to the sensing device and other elements of the car image recording system. The logic circuit is for receiving the stopping message and sending the stopping message to the other elements in the car image recording system to stop actions of the car image recording system.

### BRIEF DESCRIPTION OF THE DRAWINGS

FIG. 1 is a simplified block diagram illustrating a car image recording system with auto shut-off function according to the invention.

FIG. 2 is a block diagram illustrating a car image recording system with auto shut-off function according to one embodiment of the invention.

FIG. 3 is a block diagram illustrating a car image recording system with auto shut-off function according to another embodiment of the invention.

### DETAILED DESCRIPTION OF THE INVENTION

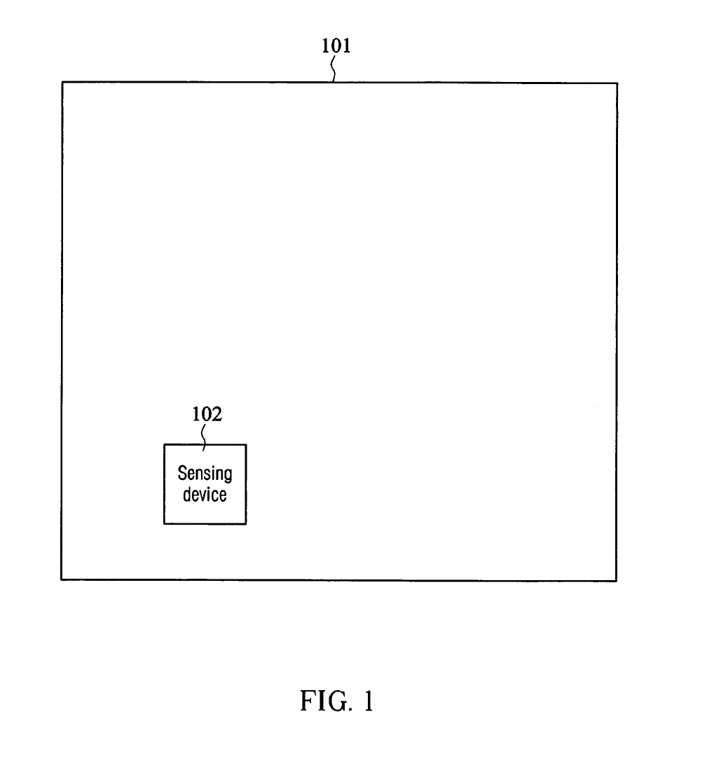

FIG. 1 is a simplified block diagram illustrating a car image recording system 101 with auto shut-off function according to the invention. As shown in FIG. 1, the car image recording system 101 includes a sensing device 102. The sensing device 102 generates a stopping message after it has sensed an external impact for a predetermined time and sends the stopping message to internal elements of the car image recording system 101, and then the car image recording system 101 stops its actions. Thus, critical images corresponding to the external impact are assured to be recorded by the car image recording system and are not recorded over. The predetermined time has no special limitation to it, and it can be adjusted according to the length of recordable time of the storage device in the car image recording system. For example, the predetermined time can be set so that actions of the car image recording system stop immediately after the impact has been sensed, or that actions of the car image recording system stop after the impact has been sensed for a few seconds, ensuring the critical images before and after the impact are not recorded over.

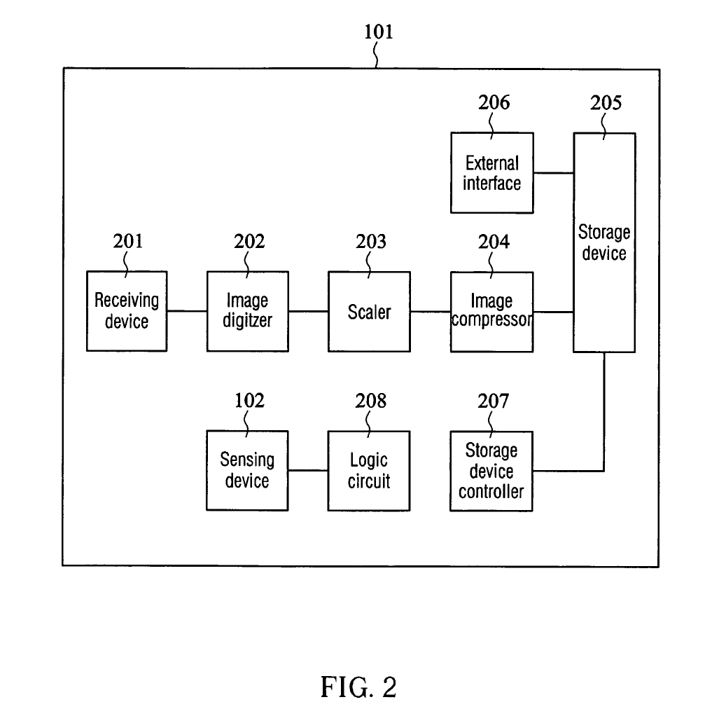

FIG. 2 is a block diagram illustrating a car image recording system 101 with auto shut-off function according to one embodiment of the invention. The car image recording system 101 includes: a receiving device 201, an image digitizer 202, a scaler 203, an image compressor 204, a storage device 205, an external interface 206, a storage device controller 207, and a logic circuit 208. The receiving device 201 receives images from outside and sends the images to the image digitizer 202. The image digitizer 202 transforms the original analog image data into digital image data; the image data is then sent to the scaler 203. The scaler 203 scales the image data to a required resolution and then sends the image data to the image compressor 204. The image compressor 204 compresses the image data and stores it in the storage device 205. The storage device 205 is controlled by the storage device controller 207. The data stored in the storage device 205 can be read out and sent to an external medium via the external interface 206. The logic circuit 28 is connected to the receiving device 201, the image digitizer 202, the scaler 203, the image compressor 204, the storage device 205, the external interface 206, the storage device controller 207 (not illustrated), and the sensing device 102. The logical circuit 208 receives the stopping message from the sensing device 102 and sends the stopping message to other elements in the car image recording system to stop the actions of the car image recording system. In this embodiment, the storage device 205 is a flash RAM; other kinds of storage device can also be used to achieve the same result.

It is to be noted that though the aforementioned car image recording system consists of a receiving device, an image digitizer, a scaler, an image compressor, a storage device, an external interface, a storage device controller, and a logic circuit, it is merely used as an example but does not mean that the invention is restricted to the car image recording system consisting of the abovementioned elements. Car image recording system belongs to a conventional technology that has been well developed; the internal circuit is very diversified, thus cannot be enlisted one by one. In other words, it is within the scope of the invention if a car image recording system is installed with the aforementioned sensing device.

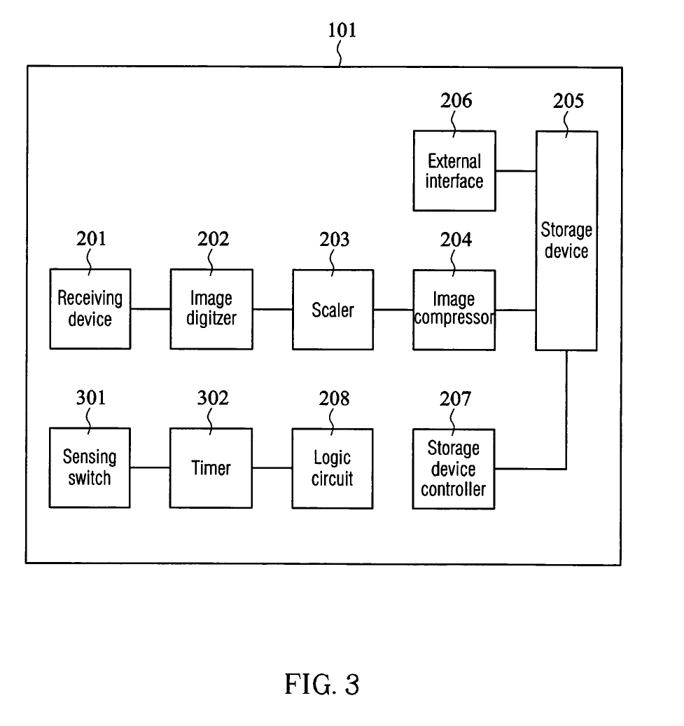

FIG. 3 is a block diagram illustrating a car image recording system 101 with auto shut-off function according to another embodiment of the invention. In comparison to FIG. 2, the sensing device 102 is replaced with more detailed circuit: a sensing switch 301, and a timer 302 connected between the sensing switch 301 and the logic circuit 208. The sensing switch 301 sends a strike message to the timer 302 when it senses an impact, and after the timer 302 has received the strike message for a predetermined time, the timer 302 generates a stopping message and sends it to the logic circuit 208. Then the logic circuit 208 sends the stopping message to other elements of the car image recording system 101 to stop the actions of the car image recording system 101.

Though the sensing device in the embodiments of the invention is composed of a sensing switch and a timer, it does not mean that the sensing device can only be composed of these two elements. Person skilled in the art can alter the design of the sensing device and achieve the same effect as the invention, and thus these kinds of alternations are not beyond the scope of the invention.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A car image recording system with auto shut-off function, comprising:
a sensing device, which sends a stopping message to stop actions of the car image recording system after having sensed an external impact for a predetermined time.

2. The car image recording system with auto shut-off function as described in claim 1, further comprising:
a logic circuit connected to the sensing device, wherein the logic circuit makes the actions of the car image recording system stop after receiving the stopping message.

3. The car image recording system with auto shut-off function as described in claim 1, wherein the sensing device comprises a sensing switch and a timer, the sensing switch generates and sends a strike message to the timer after sensing an external impact, and the timer generates a stopping message after having received the strike message for a predetermined time for stopping the actions of the car image recording system.

4. The car image recording system with auto shut-off function as described in claim 3, further comprising:
a logic circuit connected to the timer, wherein after the logic circuit receives the stopping message, the logic circuit makes the actions of the car image recording system stop.

5. A car image recording system with auto shut-off function, which comprises a receiving device, an image digitizer, a scaler, an image compressor, a storage device, and a storage device controller, the car image recording system is characterized in that:
further comprises a sensing device, wherein the sensing device sends a stopping message after having sensed an external impact for a predetermined time for stopping actions of the car image recording system.

6. The car image recording system with auto shut-off function as described in claim 5, wherein the sensing device further comprises an external interface for connecting with external devices.

7. The car image recording system with auto shut-off function as described in claim 5, further comprising:
a logic circuit connected to the sensing device, wherein after the logic circuit receives the stopping message, the logic circuit makes the actions of the car image recording system stop.

8. The car image recording system with auto shut-off function as described in claim 5, wherein the sensing device comprises a sensing switch and a timer, the sensing switch generates and sends a strike message to the timer after sensing an external impact, and the timer generates a stopping message after having received the strike message for a predetermined time for stopping the actions of the car image recording system.

9. The car image recording system with auto shut-off function as described in claim 8, further comprising:
a logic circuit connected to the timer, the receiving device, the image digitizer, the scaler, the image compressor, the storage device, and the storage device controller, wherein the logic circuit receives the stopping message and sends the stopping message to the receiving device, the image digitizer, the scaler, the image compressor, the storage device, and the storage device controller for stopping the actions of the car image recording system.

10. A sensing device for being used in a car image recording system, comprising:
a sensing switch; and
a timer,
wherein the sensing switch generates a strike message after sensing an external impact and sends the strike message to the timer, and the timer generates a stopping message after having received the strike message for a predetermined time for stopping the actions of the car image recording system.
